(19) United States
(12) Patent Application Publication
(10) Pub. No.: US 2016/0315510 A1
(43) Pub. Date: Oct. 27, 2016

(54) Axial Gap Type Motor

(71) Applicant: HITACHI AUTOMOTIVE SYSTEMS, LTD., HItachinaka-shi (JP)

(72) Inventors: Shohichi KAWAMATA, Tokyo (JP); Yuji ENOMOTO, Tokyo (JP); Kunihiko NORIDUKI, Tokyo (JP); Kenya TAKARAI, Hitachinaka (JP)

(73) Assignee: Hitachi Automotive Systems, Ltd., Ibaraki (JP)

(21) Appl. No.: 15/104,558

(22) PCT Filed: Nov. 10, 2014
(86) PCT No.: PCT/JP2014/079701

§ 371 Date: Jun. 15, 2016

(30) Foreign Application Priority Data
Jan. 10, 2014 (JP) 2014-002933

(51) Int. Cl. H02K 1/18; H02K 15/04; H02K 21/24; H02K 1/16; H02K 1/27

(52) U.S. Cl. CPC H02K 1/182; H02K 1/16; H02K 1/2793; H02K 21/24; H02K 15/045; H02K 2213/03

(57) ABSTRACT

It is an object of the present invention to provide an axial gap type motor in which continuously wound coils can be easily assembled as a stator coil of the axial gap type motor, and the workability for the work of winding wires without any connecting wire on a gap surface can be improved. The axial gap type motor includes a stator and a rotator facing each other in a rotation shaft direction, and the stator is arranged with a plurality of cores and a plurality of winding wire coils wound around the cores arranged in a circumferential direction. First, second, and third winding wire coils are wound, with a single continuous conducting wire, around first, second, and third cores arranged in order adjacent to each other in the circumferential direction. A winding direction of the second winding wire coil wound around the second core located in a center and winding directions of the first and third winding wire coils wound around the first and third cores both being located adjacent to the second core are a negative direction.

### TECHNICAL FIELD

The present invention relates to an axial gap type motor, and more particularly, to a wire winding technique suitable for an axial gap type motor in which the number of cores (slots) is constituted by a multiple of nine, e.g., a slot combination of rotators and stators is eight poles and nine cores (slots).

### BACKGROUND ART

In recent years, as the global warming escalates, a demand for saving energy in electric devices is increasing. Currently, about 55% of annual electric power consumption in Japan is consumed by motors, and therefore, a higher efficiency of a motor attracts a great deal of attention. In the past, in order to increase an efficiency of a motor, designs using rare earth magnets having high energy products have been employed. However, the prices of neodymium and dysprosium which are materials of rare earth magnets are greatly increasing in recent years. Therefore, axial gap type motors that can achieve a high degree of efficiency of a motor with only a ferrite magnet without using any rare earth magnet has attracted attention. A larger magnet size can be obtained in the axial gap type motor than in the radial gap type motor, and the axial gap type motor can compensate the reduction in the holding power of the ferrite magnet. In general, the axial gap type motor includes multiple cores, and is arranged with a stator made by winding a winding wire around the core and two rotators at both surfaces in the axial direction.

A background art in this technical field includes JP S46-7928 A (PTL 1). This publication is characterized in having a winding wire wound around a pole piece, and is characterized in that these winding wires in which an alternate current is passed is wound around the pole piece formed with a magnetically soft ferrite material (see claims). There is JP 2012-50250 A (PTL 2) as background art in this technical field. This publication describes, for the purpose of high precision positioning of a stator core and simplification of production steps when the rotational electric machine is assembled, an axial gap type rotational electric machine including a first space at a central portion of a cylindrical shape, an accommodating frame body having multiple second spaces on circumferences at equal distances from the center, a shaft provided to be rotatable in the first space, a core arranged in the second space and a coil wound around the core, a rotor yoke fixed to the shaft and arranged with multiple magnets at circumferential direction positions facing the core, and a case having a hole into which the shaft is inserted and accommodating the accommodating frame body and the rotor yoke (see abstract).

### CITATION LIST

### Patent Literature

PTL 1: JP S46-7928 A

PTL 2: JP 2012-50250 A

### SUMMARY OF INVENTION

### Technical Problem

PTL 1 discloses a single phase synchronous electric generator having an axial gap structure constituted by eight pole pieces and in which the number of magnetic poles of the rotators is eight poles. In this single phase synchronous electric generator, the winding wire has the same number of magnetic poles of the pole pieces and the rotators, and therefore, in accordance with the magnetic poles (N pole S pole) of the rotators, the winding wire is considered to be wound continuously as follows: positive direction, negative direction, positive direction, negative direction. PTL 2 discloses an axial gap rotational electric machine in which the number of cores is nine and the number of magnetic poles of the rotators is eight poles, but does not disclose winding wire methods such as a star connection and a delta connection of the coil winding wire. In general, the production steps of motors include wire connection works such as connection of connecting wire and neutral points of the winding wires.

In particular, in the axial gap type motor, when there is a wire such as a connecting wire on a gap surface between a stator core and a permanent magnet, it is necessary to consider damages of wires caused by surface deflection of the rotators, foreign objects, and the like. When the gap length of the stator core and the permanent magnet is increased in view of the damage of the wire, the performance of the motor is significantly reduced. On the other hand, the external diameter of the stator is increased for the wiring, the size of the motor increases.

Therefore, it is an object of the present invention to provide an axial gap type motor in which a continuously wound coil can be easily assembled as a stator coil of the axial gap type motor and capable of improving the workability of wire winding work without any connecting wire on the gap surface.

### Solution to Problem

An axial gap type motor according to the present invention is an axial gap type motor in which the number of slots (cores) is constituted by a multiple of nine such as, for example, a slot combination of eight poles and nine slots (cores), wherein three cores for a single phase is configured as a single set, and a single conducting wire is wound continuously on three winding wire coils.

### Advantageous Effects of Invention

According to the present invention, an axial gap type motor in which a continuously wound coil can be easily assembled as a stator coil of the axial gap type motor and which has the connecting wire between the cores so that there is no connecting wire on the gap surface of the stator core and the permanent magnet can be provided, and the workability of wire winding work can be improved.

The problems, configurations, and the effects other than the above are clarified from the explanation about the embodiments below.

### BRIEF DESCRIPTION OF DRAWINGS

FIG. 1 is a schematic cross sectional view illustrating an internal structure of an axial gap type motor according to an embodiment of the present invention.

FIG. 2 is a schematic perspective view illustrating a stator according to an embodiment of the present invention.

FIG. 3 is a connection diagram of stator winding wires according to an embodiment of the present invention.

FIG. 4A is an explanatory diagram of a coil assembly procedure for a single phase according to an embodiment of the present invention, and is a figure illustrating a first procedure thereof.

FIG. 4B is an explanatory diagram of a coil assembly procedure for a single phase according to an embodiment of the present invention, and is a figure illustrating a second procedure thereof.

FIG. 4C is an explanatory diagram of a coil assembly procedure for a single phase according to an embodiment of the present invention, and is a figure illustrating a third procedure thereof.

FIG. 5A is a schematic perspective view illustrating a stator according to an embodiment of the present invention, and a figure illustrating an example in which coils are connected in parallel.

FIG. 5B is an enlarged view illustrating a VB portion illustrating in FIG. 5A.

FIG. 6 is a connection diagram illustrating a stator winding wire according to an embodiment of the present invention, and is a figure illustrating an example in which coils are connected in parallel.

### DESCRIPTION OF EMBODIMENTS

Hereinafter, an embodiment of the present invention will be explained with reference to the drawings.

### First Embodiment

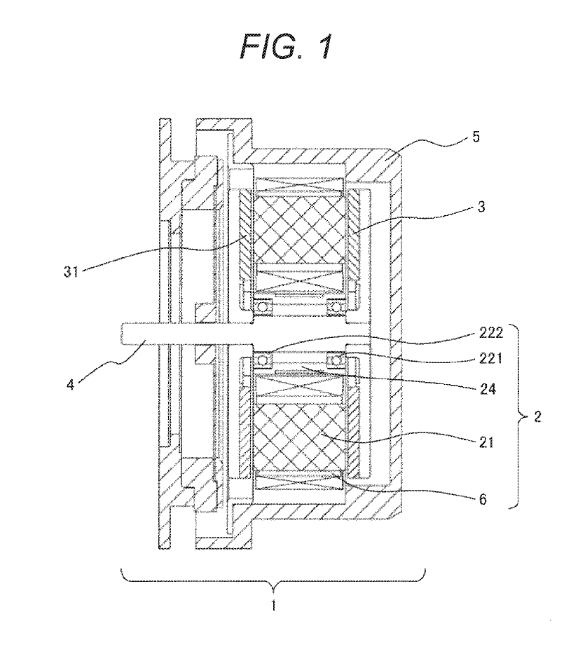

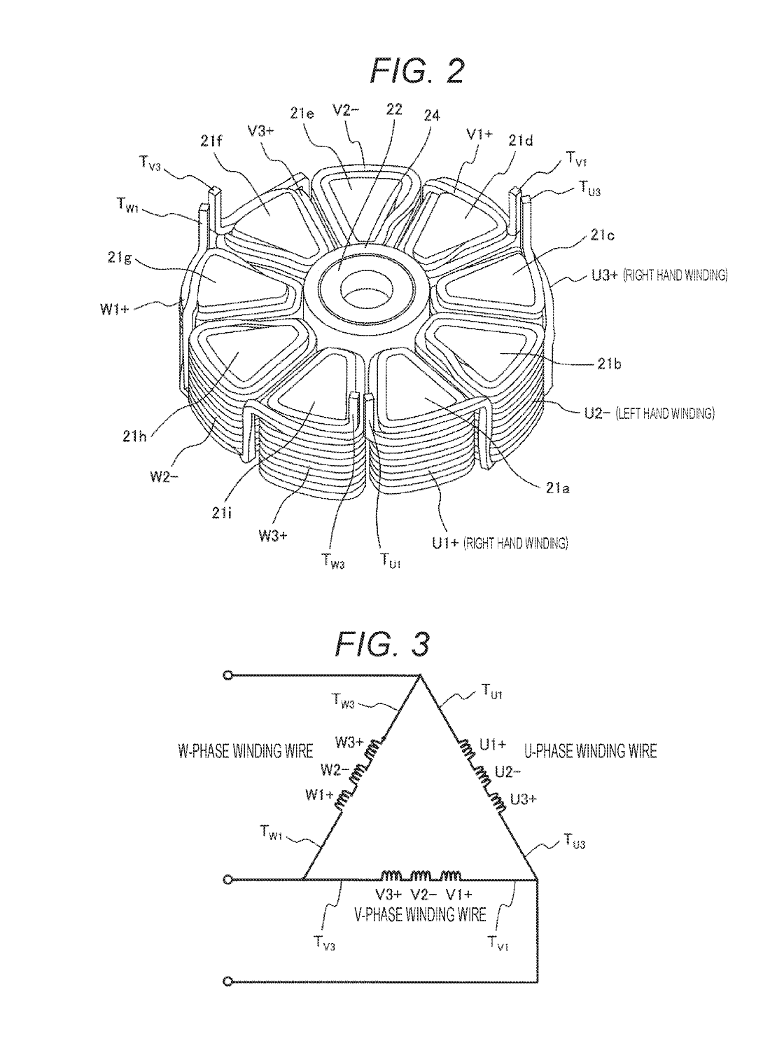

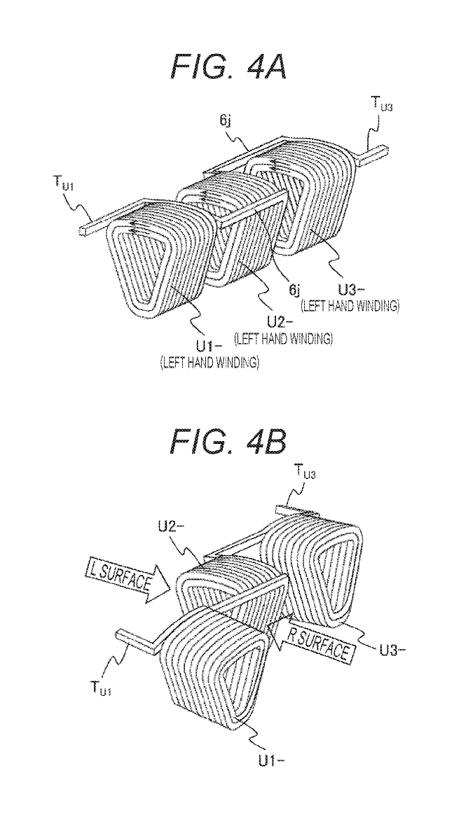

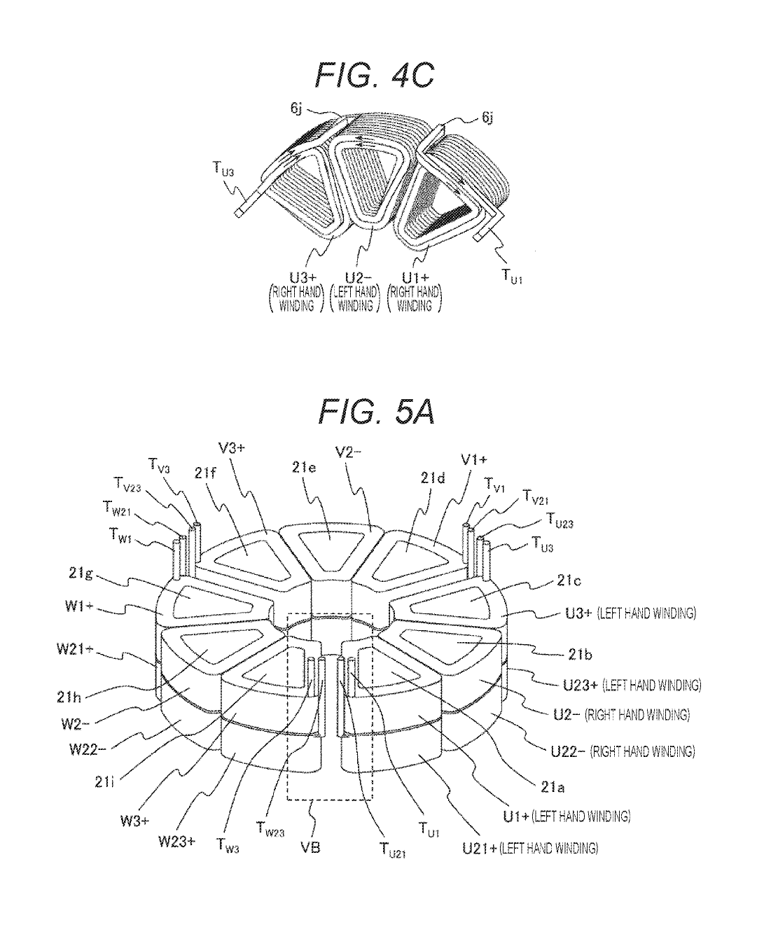

The first embodiment according to the present invention will be explained with reference to FIG. 1 to FIG. 4C. FIG. 1 is a cross sectional view illustrating an axial gap type motor 1 according to the present embodiment. FIG. 2 is a perspective view illustrating a stator 2 according to the present embodiment. FIG. 3 is a connection diagram illustrating a stator winding wire according to the present embodiment. FIGS. 4A to 4C are explanatory diagrams of an assembly procedure of a coil for a single phase according to the present embodiment, in which FIG. 4A is a figure illustrating the first procedure thereof, FIG. 4B is a figure illustrating the second procedure thereof, and FIG. 4C is a figure illustrating the third procedure thereof.

This axial gap type motor 1 includes a stator 2 formed into a flat cylindrical shape and a pair of permanent magnet rotators 3, 31 arranged at both sides in the axial direction of the stator 2 to face the stator 2 with a predetermined gap. The permanent magnet rotators 3, 31 are fixed to an output shaft 4 outputting a rotation driving force. It should be noted that the stator 2 and the permanent magnet rotators 3, 31 are accommodated in the housing 5.

In the present embodiment, the permanent magnet rotators 3, 31 are arranged at both surfaces in the axial direction with the stator 2 interposed therebetween, but any one of them may be arranged, and in the present embodiment, the configuration of the permanent magnet rotators may have the functions required for constituting the axial gap type motor 1. As illustrated in FIG. 2, the stator 2 is arranged with multiple cores 21 (21a to 21i) in the circumferential direction with the rotation shaft 4 serving as the output shaft is the central axis. Winding wires coil 6 (U1+, U2−, U3+, V1+, V2−, V3+, W1+, W2−, W3+) are wound around the external circumference of the cores 21 (21a to 21i).

The winding wire coil U1+ is wound around the core 21a, the winding wire coil U2− is wound around the core 21b, the winding wire coil U3+ is wound around the core 21c, the winding wire coil V1+ is wound around the core 21d, the winding wire coil V2− is wound around the core 21e, the winding wire coil V3+ is wound around the core 21f, the winding wire coil W1+ is wound around the core 21g, the winding wire coil W2− is wound around the core 21h, and the winding wire coil W3+ is wound around the core 211. More specifically, in the present embodiment, a configuration of nine slots constituting by nine cores is employed, and three winding wire coils are arranged for each of the phases of U, V, and W.

A pair of bearings 221, 222 is arranged in the central portion of the stator 2. In this example, the bearings 221, 222 are constituted by ball bearings, and the inner rim thereof is inserted into the output shaft 4, and the outer rim, thereof is inserted into the bearing holder 24. In the present embodiment, the configuration of the bearings 221, 222 is not limited to the ball bearing. Alternatively, bearings other than the ball bearings such as rolling bearings and sliding bearings may be employed. The number of bearings is not limited to two.

Essential portions of the present embodiment will be explained with reference to FIG. 1, FIG. 2. The U-phase winding wire (U1+, U2−, U3+), the V-phase winding wire (V1+, V2−, V3+), and the W-phase winding wire (W1+, W2−, W3+) are wound around the external peripheries of the cores (slots) 21a, to 21i of the stator 2 of the axial gap type motor 1, and the cores 21a to 21i are arranged in the circumferential direction of the stator 2.

The connection method of the nine winding wire coils 6 (U1+, U2−, U3+, V1+, V2−, V3+, W1+, W2−, W3+) in FIG. 2 may be, for example, the delta connection as illustrated in FIG. 3. In a permanent magnet rotational electric machine for an automobile, the driving power source is a battery, which is as low as 12 V. Therefore, as compared with the star connection, the delta connection can increase the terminal voltage of the winding wire coil 6 by √3 times. Accordingly, with the same output, the phase current can be reduced, and therefore, the diameter of the winding wire coil 6 can be reduced. In the embodiment of the delta connection, the work of winding wires can be easily performed, and the space factor of the winding wire coil 6 between the cores can be improved. Therefore, the axial gap type motor 1 having a high degree of efficacy can be provided.

The work of winding wires of the stator having the form as illustrated in FIG. 2 and FIG. 3 are wound for each of the phases of the U-phase winding wire (U3+, U2−, U1+), the V-phase. winding wire (V3+, V2−, V1+), and the W-phase winding wire (W3+, W2−, W1+), and is carried out by continuously winding each of the three winding wires constituting each phase with a single wire as illustrated in FIG. 4A to FIG. 4C. In this case, T_{W3}, T_{U1}, T_{U3}, T_{V1}, T_{V3}, T_{W1} which are lead wire portions of the axial gap type motor 1 is formed as illustrated in the drawings and can facilitate connection with the outside. More specifically, T_{W3} and T_{U1}, T_{U3} and T_{V1}, T_{V3} and T_{W1} which are lead wire portions are connected with crimpling and the like, and for example, are extended as U-phase, V-phase, W-phase like a three-phase brushless motor, and can be used for connection wirings with an inverter (not illustrated) for motor driving.

According to the above configuration, in the connection of all the winding wire coils 6, it is sufficient to make only the connection between adjacent winding wires, and therefore, the lead wire can be shortened. When all the winding wire coils 6 of the cores (21a to 21i) are separately connected, six connection portions are made for a single phase, and totally, 18 connection portions are made for the three phases. In contrast, in the present embodiment, it is sufficiently to make connection at only three portions, i.e., between T_{W3} and T_{U1}, between T_{U3} and T_{V1}, and between T_{V3} and T_{W1}, and the connection portions can be greatly reduced, and this can greatly reduce the electric work (connection work of the winding wire coils).

This can greatly reduce the resistance loss caused by connection portions, and improves the efficiency.

In this case, + and − signs indicated at each of the winding wires of the phases indicate that, where the sign − is the left hand winding, the sign + indicates that the conducting wire is wound in the right hand winding which is opposite to the sign −. In the following explanation, the sign + indicates the right hand winding, and the sign indicates the left hand winding. In a case where the right hand winding is a positive direction wind, the left hand winding is a negative direction winding. In a case where the left hand winding is a positive direction winding, the right hand winding is a negative direction winding. The signs − and + indicate positive and negative relationship of the winding direction, and the signs − and + may be defined in any given direction of the positive and negative directions.

Subsequently, an assembly method of the winding wire coil 6 will he explained. In FIG. 2, the U-phase winding wire (U1+, U2−, U3+) wound around the cores 21a to 21c, the V-phase winding wire (V1+, V2−, V3+) wound around the cores 21d to 21f, and the W-phase winding wire (W1+, W2−, W3+) wound around the cores 21g to 21i have the same configuration, and therefore, in this case, the U-phase winding wire (U1+, U2−, U3+) wound around the cores 21a to 21c will be explained as an example.

In the winding wire method according to the present embodiment, the U-phase winding wires U1+, U2−, U3+ wound around the cores 21a, 21b, 21c are continuously wound with a single conducting wire. More specifically, the winding wires U1+, U2−, U3+ are wound around the winding wires U3−, U2−, U1− in this order with a winding wire jig (not illustrated) winding continuously in the same axial direction and in the same rotation direction with a single conducting wire. A state where the winding wire that has been wound is detached from the winding wire jig is illustrated in FIG. 4A. It should be noted that the winding directions (the left hand winding and the right hand winding) of the winding wire is explained as a winding direction when the winding wire is seen from the positive surface (U1-side) in FIG. 4A. In this state, the winding wire U1−, the winding wire U2−, the winding wire U3− are arranged straightly in this order. In this state, any of the winding wires U1−, U2−, and U3− is in the state of the left hand winding, and the winding directions are the same. The arrows illustrated in the drawings indicate the winding direction.

In the present embodiment, any of the winding wires U1−, U2− and U3− is wound twice on the external peripheries of the cores 21a to 21c. When the winding wire U3− is wound twice, the winding wire at the inner circumferential side is wound by winding along the winding axial direction from the start of winding, and when the winding wire at the inner circumferential side is wound along the winding axial direction when the winding wire at the inner circumferential side has been wound, the winding wire at the external peripheral side is wound by winding the winding wire in the negative direction. In the present embodiment, the winding wire at the inner circumferential side is wound from the farther side to the closer side in FIG. 4A, and is switched back at the closer side and wound toward the farther side. When the winding wire at the external peripheral side has been wound, a portion serving as a connecting wire 6j is provided, and the winding wire U2− is wound in the same manner as the winding wire U3−, and subsequently, U1− is wound in the same manner as the winding wire U3−. At this occasion, the portion serving as the connecting wire 6j between the winding wire U1− and the winding wire U2− and the portion serving as the connecting wire 6j between the winding wire U2− and the winding wire U3− are wound in such a manner that the portion serving as the connecting wire 6j between the winding wire U1− and the winding wire U2− and the portion serving as the connecting wire 6j between the winding wire U2− and the winding wire U3− are located separately at both sides with the winding wires U1−, U2−, and U3− interposed therebetween (at the L surface side and the R surface side in FIG. 4B).

In order to arrange the connecting wire 6j as illustrated in FIG. 2, the winding wires U1−, U2−, and U3− are preferably wound in an overlapping manner for an even number of times. In the present embodiment, the winding wires U1−, U2−, and U3− are wound twice (two lavers) in an overlapping manner.

Subsequently, as illustrated in FIG. 4B and FIG. 4C, with respect to the winding wire U2− in the center, the winding wire U1− at one side is reversed 180 degrees with respect to the R surface, so that it is arranged at the right side surface of the winding wire U2− and made into a winding wire U1+. At this occasion, the winding wire U1 is flipped upside down in the axial direction, and the winding wire U1 is changed from the winding wire U1− of the left hand winding into the winding wire U1+ of the right hand winding. Subsequently, with reference to the winding wire U2−, the winding wire U3− at the other side is reversed 180 degrees with respect to the L surface of the winding wire U2−, and is arranged at the left side surface of the winding wire U2−. At this occasion, the winding wire U3 is flipped upside down in the axial direction, and the winding wire U3 is changed from the winding wire U3− of the left hand winding into the winding wire U3+ of the right hand winding. Therefore, as illustrated in FIG. 4C, the U-phase winding wires U1+, U2−, U3+ are arranged on the circumferential manner on the same flat surface.

According to the winding wire method explained in FIG. 4A, FIG. 4B, and FIG. 4C, one of the winding wire end portions of the winding wire U1+ which is a first winding wire coil is drawn out as the lead wire T_{U1}. The other of the winding wire end portions of the winding wire U1+ passes through the first connecting wire 6j and becomes one of the winding wire end portions of the winding wire U2− which is a second winding wire coil. The other of the winding wire end portions of the winding wire U2− passes through the second connecting wire 6j and becomes one of the winding wire end portions of the winding wire U3+ which is a third winding wire coil. The other of the winding wire end portions of the winding wire U3+ is drawn out as the lead wire T_{U3}. The one of the winding wire end portions of the winding wire U1+ and the other of the winding wire end portions of the winding wire U3+ are located at the same side in the rotation shaft direction. The one of the winding wire end portions and the other of the winding wire end portions of the winding wire U2− are located at the same side in the rotation shaft direction, and are located at the opposite side in the rotation shaft direction with respect to the one of the winding wire end portions of the winding wire U1+ and the other of the winding wire end portions of the winding wire U3+.

Subsequently, the same steps are repeated for the other phases (the V-phase and the W-phase), and the winding wire coils V1+, V2−, V3+ and W1+, W2−, W3+ for the remaining V-phase and W-phase are arranged, and the cores 21a to 21i are inserted into the winding wire coils (U1+ to W3+), so that the stator 2 of the axial gap type motor having the cores 21a to 21i around which the winding wire coil 6 is wound is completed. It should be noted that the winding wire coil 6 and the cores 21a to 21i are integrated with resin mold and the like.

In the present embodiment, the winding wire coil 6 is wound in the same axial direction and in the same rotation direction, so that the workability and the precision of the production of the winding wire coil 6 are improved. Further, the connecting wire 6j can be arranged between the winding wire coils of each phase (between the U-phase winding wires U1+, U2−, U3+ and the V-phase winding wires V1+, V2−, V3+, between the V-phase winding wires V1+, V2−, V3+ and the U-phase winding wires W1+, W2−, W3+, and between the W-phase winding wires W1+, W2−, W3+ and the U-phase winding wires U1+, U2−, U3+), and therefore, the connecting wire at the gap surface side of the stator 2 can eliminated. Therefore, the connecting wire is not damaged by surface deflection of the rotator, foreign objects, and the like, and the motor can have a high degree of reliability.

Between the winding wire coils 6 wound around the two adjacent coils, a streak-like groove 6a (see FIG. 2) extending in the rotation shaft direction is formed at the bent portion of the coil winding wire 6 at the external peripheral side. The connecting wire 6j is arranged at this groove 6a, so that the expansion of the diameter direction size can also be suppressed.

### Second Embodiment

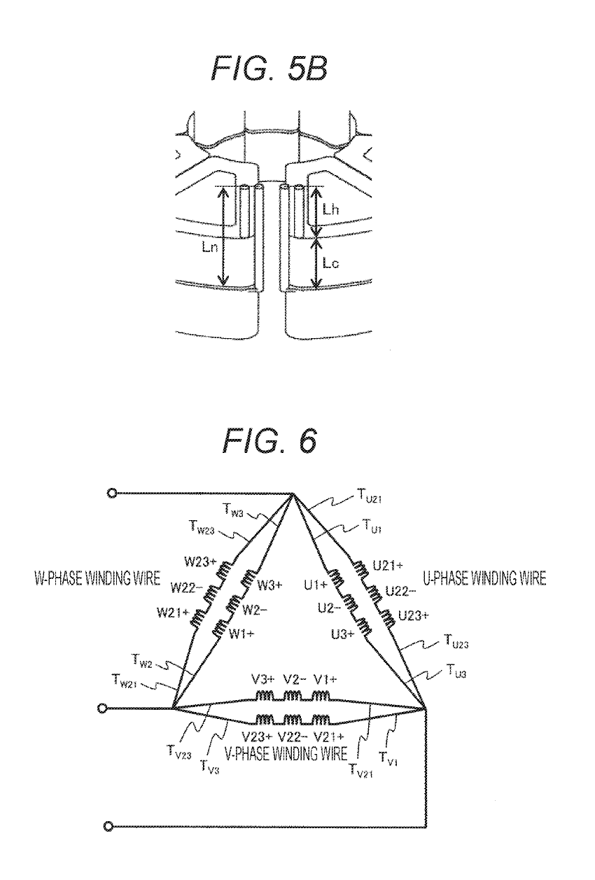

The second embodiment according to the present invention will be explained with reference to FIG. 5A, FIG. 5B, and FIG. 6. FIG. 5A is a schematic perspective view illustrating a stator according to the present embodiment, and is a figure illustrating an example in which coils are connected in parallel. FIG. 5B is an enlarged view illustrating a VB portion (wavy line portion) as illustrated in FIG. 5A. FIG. 6 is a connection diagram illustrating a stator winding wire according to the present embodiment, and is a figure illustrating an example where coils are connected in parallel.

In the present embodiment, two winding wire coils 6 are arranged in a stacked manner in the rotation shaft direction of the rotators 3, 31. This may be considered that, in the axial gap type motor cross sectional view of FIG. 1, a single stage of (one layer of) winding wire coil 6 is configured in the axial center direction of the output shaft 4, but in the second embodiment, two stages of (two layers of) winding wire coils 6 are configured.

In the present embodiment, as illustrated in FIG. 5A, two winding wire coils 6 are connected in parallel. In FIG. 5A and FIG. 5B, for example, two stages of winding wires are stacked in the axial direction, and the terminal portions (T_{U1}, T_{U21}; T_{W3}, T_{W23}; T_{U3}, T_{U23}; T_{V1}, T_{V21}; T_{V3}, T_{V23}; and T_{W1}, T_{W22}) of the lead wires of the winding wire coils (U1+ to W3+) are connected, so that as each phase is illustrated in the connection diagram of FIG. 6, the U-phase winding wires U1+, U21+ and the W-phase winding wires W3+, W23+; the U-phase winding wires U3+, U23+ and the V-phase winding wires V1+, V21+; and the V-phase winding wires V3+, V23+ and the W-phase winding wires W1+, W21+ can be easily connected in parallel. In this case, the length of the lead wire of the winding wire coil 6 in the second stage is increased to be the same height as the lead wire of the first stage, so that they can be connected at one of the gap surface sides of the stator 2.

In the configuration of the present embodiment, two parallel circuits are provided for each phase, and therefore, the diameter of the conductive body of each winding wire coil 6 can be reduced (for example, from φ2 to φ1.4). Therefore, the work of winding wires can be further facilitated, and the space factor between the cores (21a to 21i) of the winding wire coil 6 is enhanced, and the motor having a small size and a light weight as well as having a high degree of efficiency can be made.

Hereinafter, lead wire lengths in the configuration in which multiple stages of winding wire coils 6 are arranged will be explained. In the configuration in which multiple stages of winding wire coils 6 are arranged, where the lead wire length in the first stage is denoted as Lh, and the axial direction length of the winding wire coil 6 in the first stage is denoted as Lci, the lead wire length Ln in the n-th stage is preferably configured to be approximately Ln=Lh+(n−1)*Lci (where n is a number of stages of the stators and is a positive integer).

For example, where all the lead wire lengths of the stages are the same length, the delta connection and the wiring of the lead wires between the winding wire coils (U-phase and V-phase; V-phase and W-phase; W-phase and U-phase) are made between the winding wire coils, and this raises complicated wiring work and insulating processing. There may be a risk of motor damage due to short-circuit between the winding wire coils. In the present embodiment, the core around which the winding wire coil 6 in the first stage is wound and the core around which the winding wire coil 6 in the second stage is wound are integrated, but the cores may be divided in each stage. In this case, the axial direction length Lci of the winding wire coil 6 used in the above expression may be the axial direction length Lco of the core in the first stage.

In the present embodiment, the lead wire length Ln in the n-th stage is set as described above, so that the terminal portions of the lead wires (T_{U1} to T_{W3} and T_{U21} to T_{W23}) can be wires at one of the gap surface sides and at the outside of the winding wire coil 6. Therefore, the motor damage due to short-circuit between the winding wire coils (U-phase and V-chase; V-chase and W-phase; and W-phase and U-phase) can be eliminated, and the motor having a high degree of reliability can be provided. Further, the stator coils 6 in the stages are preferably stacked with an insulating sheet interposed therebetween. In this case, the molding pressure in the axial direction for the stator coils 6 stacked during molding and the like can be increased, and therefore, the space factor can be further improved.

In the above embodiments, for example, the number of coils is nine (nine slots) and the number of magnetic poles of the permanent magnets of the permanent magnet rotators is eight poles, but the same effects can be obtained even when the number of magnetic poles of the permanent magnets is ten poles. In this case, the cogging torque generated by the repulsive and attracting forces between the cores and the permanent magnets can be further reduced, and the vibration and the noises of the motor and the system having the motor incorporated therein can be reduced.

The number of slots is not limited to nine slots, and a configuration including as many slots as a multiple of nine may be used.

In the present embodiment, a rectangular wire is used, but the same effects can also be obtained even when a round wire is used. The core material is not disclosed in the present embodiment, but the core material is not particularly limited. Any of electromagnetic steel sheet, dust core, amorphous, and the like may be used depending on the specification of the motor.

It should be noted that the present invention is not limited to each of the embodiments described above, and various modifications are included. For example, the above embodiment is explained in details in order to explain the present invention so that it can be easily understood, and is not necessarily limited to those having all of the elements. Some of the elements in each embodiment may be added to other elements, or may be deleted or replaced with other elements.

### REFERENCE SIGNS LIST

1 . . . axial gap type motor, 2 . . . stator, 21a to 21i . . . core, 221, 222 . . . bearing, 3, 31 . . . permanent magnet rotator, 4 . . . output shaft, 5 . . . housing, 6 . . . winding wire coil, 6a . . . streak-like groove, 6j . . . connecting wire, U (U1+, U2−, U3+, U1−, U3−, U21+, U22−, U23+) . . . multiple U-phase winding wires, V (V1+, V2−, V3+, V21+, V22−, V23+) . . . multiple V-phase winding wires, W (W1+, W2−, W3+, W21+, W22−, W23+) . . . multiple W-phase winding wires, T (T_{U1} to T_{W3} and T_{U21} to T_{W23}) . . . terminal portion of lead wire

1.-11. (canceled)

12. An axial gap type motor comprising a stator and a rotator facing each other in a rotation shaft direction, the stator being arranged with a plurality of cores and a plurality of winding wire coils wound around the cores arranged in a circumferential direction,
wherein a number of cores arranged in the stator are a multiple of nine,
first, second, and third winding wire coils are wound, with a single continuous conducting wire, around first, second, and third cores arranged in order adjacent to each other in the circumferential direction, and a winding direction of the second winding wire coil wound around the second core located in a center and winding directions of the first and third winding wire coils wound around the first and third cores both being located adjacent to the second core are a negative direction,
one of the winding wire end portions of the first winding wire coil is drawn out as a lead wire,
the other of the winding wire end portions of the first winding wire coil passes through a first connecting wire and becomes one of the winding wire end portions of the second winding wire coil,
the other of the winding wire end portions of the second winding wire coil passes through a second connecting wire and becomes one of the winding wire end portions of the third winding wire coil,
the other of the winding wire end portions of the third winding wire coil is drawn out as a lead wire,
the one of the winding wire end portions of the first winding wire coil and the other of the winding wire end portions of the third winding wire coil are located at the same side in a rotation shaft direction, and
the one of the winding wire end portions and the other of the winding wire end portions of the second winding wire coil are located at the same side in the rotation shaft direction, and the one of the winding wire end portions of the first winding wire coil and the other of the winding wire end portions of the third winding wire coil are located at opposite sides in the rotation shaft direction.

13. The axial gap type motor according to claim 12, wherein the first connecting wire and the second connecting wire are located inside of a winding range of the winding wire coil in rotation shaft direction.

14. The axial gap type motor according to claim 13, wherein a number of cores constituting the stator are nine, and a number of magnetic poles constituting the rotator are eight.

15. The axial gap type motor according to claim 14, wherein three sets of first winding wire coils, second winding wire coils, and third winding wire coils are provided, and each set constitutes each phase of a U-phase, a V-phase, and a W-phase.

16. The axial gap type motor according to claim 15, wherein the cores and the winding wire coils for nine poles are integrated by resin molding in such state that the cores and the winding wire coils are arranged in the circumferential direction.

17. The axial gap type motor according to claim 13, wherein a number of cores constituting the stator are nine, and a number of magnetic poles constituting the rotator are ten.

18. The axial gap type motor according to claim 14, wherein the winding wire coil is connected in a delta connection.

19. The axial gap type motor according to claim 12, wherein where an axial direction length of the winding wire coil is denotes as Lm, and an axial direction length of the core is denoted as Lco, the following expression holds: Lm≦Lco.

20. The axial gap type motor according to claim 12, wherein a plurality of stages of stators are arranged in the axial direction, and winding wire coils in the stages are connected in parallel.

21. The axial gap type motor according to claim 20, wherein a lead wire length in the first stage is denoted as Lh, and an axial direction length of the core is denoted as Lco, the lead wire length Ln of each stage is Ln=Lh+(n−1)*Lco (where n is a number of stages of stators and is a positive integer).
